(19) United States
(12) Patent Application Publication
(10) Pub. No.: US 2011/0160961 A1
(43) Pub. Date: Jun. 30, 2011

(54) GUIDANCE USING A WORKED EDGE FOR WAYLINE GENERATION

(75) Inventors: NYLE WOLLENHAUPT, MINNETONKA, MN (US); ED SWENSON, HESSTON, KS (US)

(73) Assignee: AGCO CORPORATION, Duluth, GA (US)

(21) Appl. No.: 12/649,023

(22) Filed: Dec. 29, 2009

(51) Int. Cl. G01C 21/00; B62D 6/00; G01S 19/14

(52) U.S. Cl. 701/41; 701/206

(57) ABSTRACT

Wayline generation using a worked edge may be provided. A field boundary line and first work implement width may be received. A first wayline may then be calculated according to a distance from the field boundary line comprising the width of the first work implement. The first wayline may be provided to another machine and a width of the other machine's work implement may be received. A second wayline may then be calculated according to a distance from the first wayline comprising the width of the second machine's work implement.

### BACKGROUND

Guidance using a worked edge for wayline generation is a process for providing a machine with a navigational path. In some situations, multiple machines may be in use in a single working area. For example, multiple combine harvesters may be collecting crop material in the same field. The conventional strategy is for a human operator to follow behind another harvester and navigate his machine to cover an unworked area. This often causes problems because the conventional strategy does not always result in the most efficient path, particularly for dusk or nighttime operations. For example, an operator may overlap the previous row too much, wasting a portion of the machine's head over a previously worked area, or leave a gap between harvested rows.

### SUMMARY

Consistent with embodiments of the present invention, systems and methods are disclosed for auto-detection of a field in fleet management. Wayline generation using a worked edge may be provided. A field boundary line and first work implement width may be received. A first wayline may then be calculated according to a distance from the field boundary line comprising the width of the first work implement. The first wayline may be provided to another machine and a width of the other machine's work implement may be received. A second wayline may then be calculated according to a distance from the first wayline comprising the width of the second machine's work implement.

It is to be understood that both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a block diagram of an apparatus for generating a wayline;

FIG. 3 is a flow chart of a method for providing guidance using a worked edge;

FIG. 4 is a diagram illustrating a wayline; and

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Wayline generation using a worked edge may be provided. Consistent with embodiments of the present invention, an agricultural machine may use a navigation system to assist an operator in following an efficient work path. The work path may comprise a series of data points established by a previous pass of the machine and/or a pass of another machine. For example, as a combine harvester traverses a field row collecting crop material, a Global Positioning System (GPS) on the harvester may record the path followed along with additional data such as the harvester's speed, direction, amount of crop material collected, and fuel remaining. Similarly, other machines, such as a planter or sprayer may record data such as remaining supply volume of their respective consumables (e.g., seeds, water, herbicides, and/or pesticides). These data points may be shared with other machines working in the same field, and may be stored to an on-board computer and/or transmitted to a field management system, such as the GTA Software Suite produced and distributed by AGCO® of Duluth, Ga.

These data points may be used to provide a wayline for a subsequent path through the field. Consistent with embodiments of the invention, the location of each data point may be adjusted by an offset amount to compensate for the location of the GPS component in relation to the work area covered by the machine. For example, a combine harvester may navigate such that one edge of the working header follows an existing wayline while new data points are generated with coordinates associated with the opposite edge of the header.

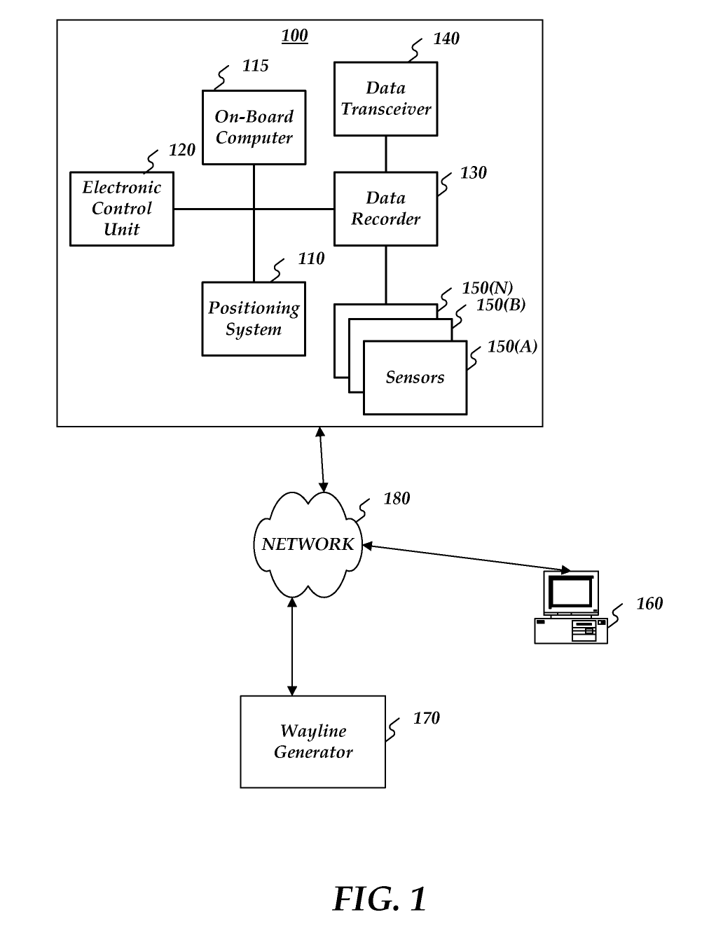

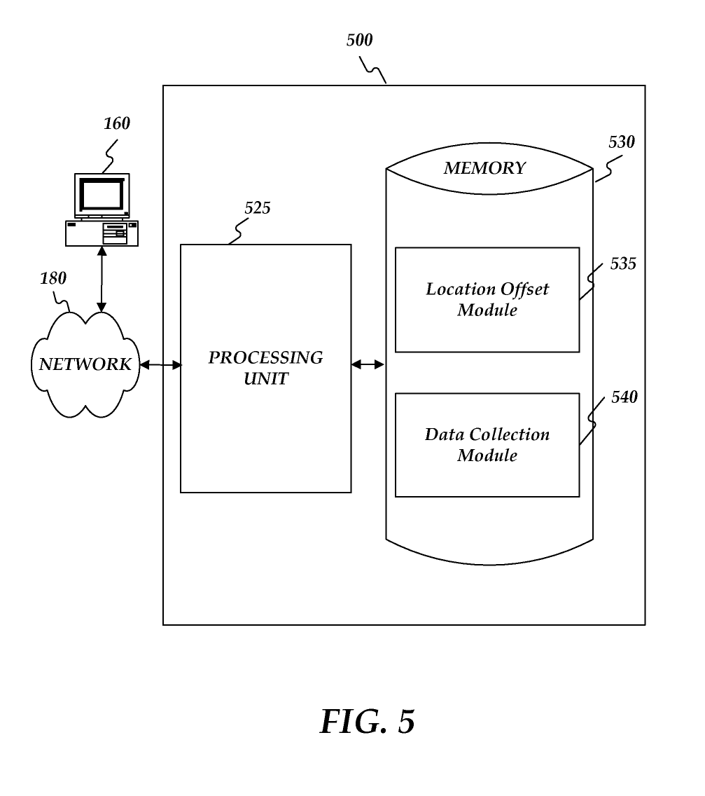

FIG. 1 is a block diagram of an operating environment for providing wayline generation. The operating environment may comprise a first wayline generator 100 comprising a positioning system 110, an on-board computer 115, an electronic control unit 120, a data recorder 130, and a data transceiver 140. Data recorder 130 may be coupled to a plurality of sensors 150(A)-150(N). Positioning system 110 may comprise, for example, a GPS system. Electronic control unit 120 may comprise an autosteer system operative to control various aspects of an apparatus' functionality, such as speed, direction, and work state. An example of such an autosteer system may comprise the Auto-Guide™ system produced and distributed by AGCO® of Duluth, Ga. The operating environment may further comprise a field management system 160 and a second wayline generator 170 communicatively coupled by a network 180. On-board computer 115 and/or field management system 160 may each comprise a computing device 500 as described in greater detail below with respect to FIG. 5.

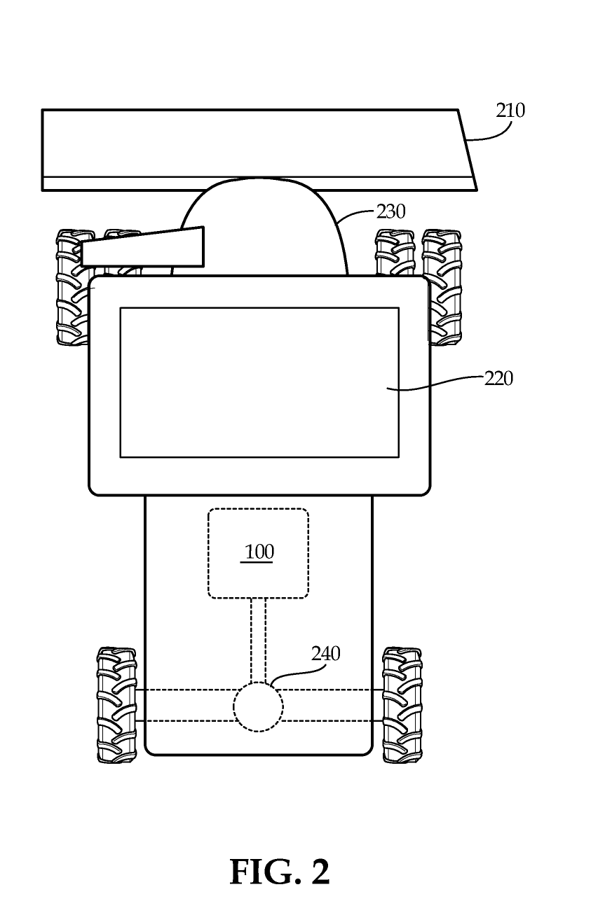

FIG. 2 is a block diagram of an apparatus 200 for generating a wayline. Apparatus 200 may comprise, for example, a harvester comprising a work implement 210, a harvested material bin 220, and an operator cab 230. Apparatus 200 may further comprise a drive system 240 comprising an engine and a steering linkage (not shown) coupled to the components of wayline generator 100. Further details regarding the components of a combine harvester are disclosed in U.S. Pat. No. 5,873,227, which is hereby incorporated by reference in its entirety. Data recorder 130 may be operative to record data points associated with apparatus 200 at various intervals based on factors such as speed, orientation, time, and/or work performed. For example, data recorder 130 may create a data point every minute recording a current speed and direction, whether or not work implement 210 is active, a crop yield for the area covered, a current level of harvested material bin 220, and an estimated time until harvested material bin 220 may be full. Consistent with embodiments of the invention, data recorder 130 may be operative to record data points more often when apparatus 200 is moving along a curve than when moving in a straight line in order to more accurately reflect the path followed.

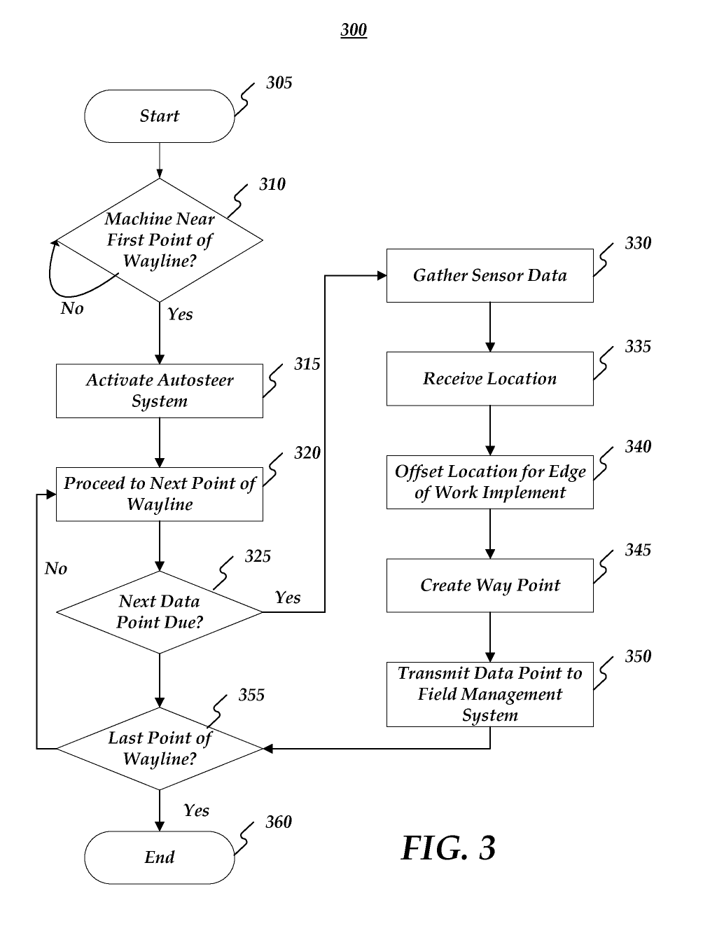

FIG. 3 is a flow chart setting forth the general stages involved in a method 300 for providing guidance using a worked edge. FIG. 3 is a flow chart setting forth the general stages involved in a method 300 consistent with an embodiment of the invention for providing wayline guidance using a worked edge. Method 300 may be implemented, for example, using computing device 500 as described in more detail below with respect to FIG. 5. Moreover, method 300 may be implemented using elements shown in FIG. 1 and FIG. 2, for example. Ways to implement the stages of method 300 will be described in greater detail below.

Method 300 may begin at starting block 305 and proceed to stage 310 where computing device 500 may determine whether it is near a first point of a wayline. For example, computing device 500 may determine whether its current position, as provided by positioning device 110, is within a threshold distance of the first point of an available wayline. This determination may further consider the orientation of apparatus 200, such as whether the first point is within a 30 degree arc of the current facing. If not, an operator of apparatus 200 may continue to pilot the vehicle until computing device 500 detects such a wayline starting point. Consistent with embodiments of the invention, computing device 500 may communicate with a field management system using data transceiver 140. Computing device 500 may periodically transmit its location to field management system 160 and, for example, request a location of the nearest wayline starting point and/or any wayline points within a given radius. Further consistent with embodiments of the invention, computing device 500 may receive periodic updates of any and/or all waylines active in a work area, such as a field, and compare its current location to the way points of those waylines to determine whether a starting point is nearby. If no starting point is within a predetermined threshold distance, computing device 500 may be operative to provide an operator/driver with guidance to a starting wayline point.

If, at stage 310, computing device 500 determines that the first point of a wayline is nearby, method 300 may advance to stage 315 where computing device 500 may activate an autosteer system. For example, an operator of apparatus 200 may be alerted to the fact that a wayline is nearby and available. The operator may accept this wayline and electronic control unit 120 may assume control of the operations of apparatus 200. The autosteer system may be operative to manipulate apparatus 200 (i.e., engage a drive and steering system) so as to place an edge of work implement 210 on the first waypoint and put work implement 210 in an active state.

From stage 320, computing device 500 may proceed to a next way point of the wayline. For example, the autosteer system may propel apparatus 200 in a straight line from the first way point to the second way point. Consistent with embodiments of the invention, the wayline may encompass arc data between way points so that apparatus 200 may follow a curved path between way points.

Method 300 may then advance to stage 325 where computing device 500 may determine whether a new data point is due to be recorded. At periodic intervals, such as once per minute, once per 50 feet, or every 5% of bin volume used, a new data point may be due to be recorded. Other factors, such as speed, work state, and orientation may affect the interval at which data points are collected. For example, data points may not be collected while work implement 210 is inactive, data points may be further spaced apart when apparatus 200 is traveleing in a straight line, and data points may be clustered more closely when apparatus 200 is slowly navigating a tight turn. For another example, data points may be recorded more frequently as a consumable level (e.g., an herbicide supply for a sprayer apparatus) drops or harvested material bin 220 nears capacity.

If a data point is due to be recorded, method 300 may advance to stage 330 where computing device 500 may gather sensor data. For example, as apparatus 200 proceeds from the first to the second way point, apparatus 200 may collect and store data from sensors 150(A)-150(N), such as a fuel level, a crop yield, and/or an available storage level of harvested material bin 220.

After gathering sensor data at stage 330, method 300 may advance to stage 335 where computing device 500 may receive a location. For example, positioning system 110 may provide current lat/long coordinates via GPS. The position and sensor data may be associated to create a data point. The data point may be further associated with other information, such as an operator name, a field identifier, an identifier for apparatus 200, and/or a timestamp.

Method 300 may then advance to stage 340 where computing device 500 may offset the current location for a way point. For example, the location may be offset by taking into account the relative positions of positioning system 110 and an edge of working implement 210 along the border of the newly worked area and an unworked area. A combine harvester, for example, may be harvesting crop material across the width of a 3 meter cutting head. One edge of the cutting head may be placed so as to follow the current wayline, which may comprise a border between a harvested and an unharvested area. The opposite edge of the cutting head may be treated as being located on a new border between the area just harvested by apparatus 200 and a remaining unharvested area. If positioning system 210 is located, for example, in the middle of the cutting head, the current location as received at stage 335 may be offset by 1.5 meters to compensate for distance between the GPS and the edge of the cutting head.

From stage 340, method 300 may advance to stage 345 where computing device 500 may create a way point. For example, the various data associated with the data point created at stage 335 and the offset location established at stage 340 may be combined into a new way point. Trajectory data may also be associated with the new way point to establish the path from a previous way point, as where apparatus 200 traveled in a curve since the last way point may have been created.

From stage 345, method 300 may advance to stage 350 where computing device 500 may transmit the way point to a field management system. Field management system 160 and/or computing device 500 may be operative to associate each way point created by computing device 500 into a wayline by assembling the way points and/or any trajectory information in the order they were created.

After transmitting the way point at stage 350, or if no data point was determined to be due at stage 325, method 300 may advance to stage 255 where computing device 500 may determine whether the most recent way point reached in the wayline being followed by computing device 500 is the last way point of the wayline. If not, method 300 may return to stage 320 and proceed to the next way point. Otherwise, method 300 may end at stage 360.

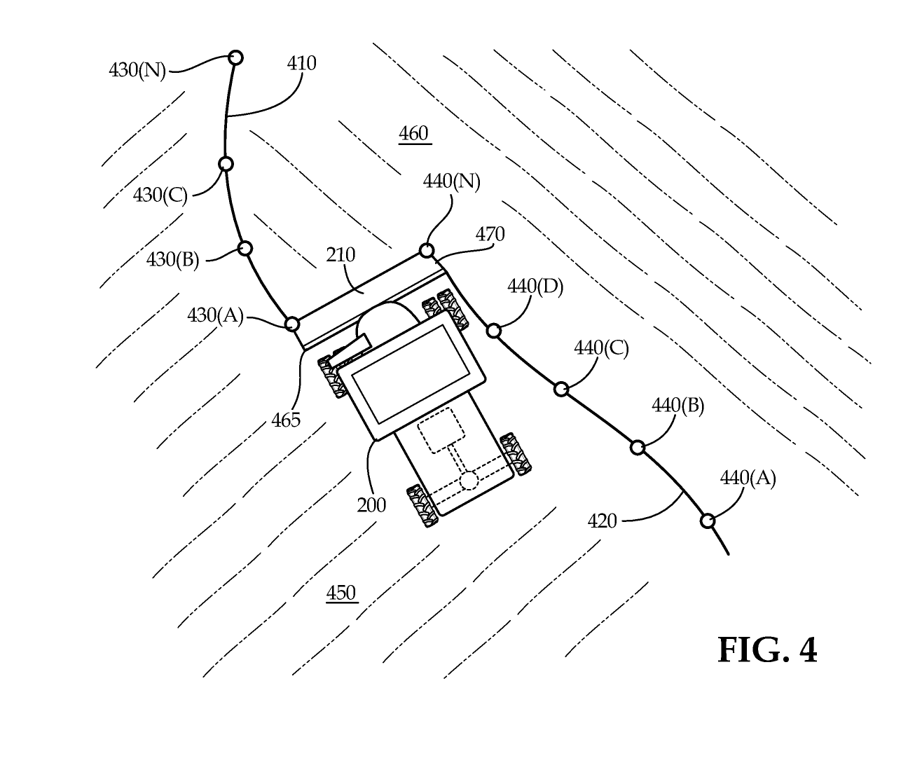

FIG. 4 is a diagram illustrating a first wayline 410 and a second wayline 420. First wayline 410 may comprise a first plurality of way points 430(A)-430(N) and second wayline 420 may comprise a second plurality of way points 440(A)-440(N). First wayline 410 and/or second wayline 420 may each comprise a boundary between a worked area 450 and an unworked area 460. For example, first wayline 410 may comprise a cut-edge between an area of already harvested crops and an area of yet-to-be harvested crops.

Consistent with embodiments of the invention, computing device 500 may receive first wayline 410 from a field management system and may engage an autosteer system to follow first wayline 410, keeping an edge 465 of working implement 210 on first wayline 410. As each way point of first wayline 410 is reached by apparatus 200 and/or working implement 210, data transceiver 140 may inform field management system 160 that the way point has been reached and field management system 160 may remove and/or deactivate the completed waypoint. Field management system 160 may thus maintain an up-to-date listing of any and/or all active waylines in a field. If apparatus 200 is unable to traverse the entire length of first wayline 410, field management system may designate the last way point reached, such as way point 430(A), as the first way point of first wayline 410 for another apparatus to begin working and/or for apparatus 200 to resume working.

Further consistent with embodiments of the invention, as apparatus 200 is following first wayline 410, computing device 500 may create each of the second plurality of way points 440-440(N). For example, computing device 500 may periodically generate a data point as described above with respect to method 300 and transmit the data point to a field management system. Each data point may comprise a plurality of data about the operation of apparatus 200, such as a current location, speed, and orientation, work state, and/or other factors.

Each data point may then be offset into a way point by taking into account the relative positions of positioning system 110 and an opposing edge 470 of working implement 210. For example, if positioning system 110 is located 1 meter to the left and 1.5 meters behind the front of opposing edge 470, the data point may be offset 1 meter to the right and 1.5 meters forward. Consistent with embodiments of the invention, a buffer region may be applied to this offset. For example, a 10 cm buffer may be used to provide an overlap of a working implement of a second apparatus with the area already worked by apparatus 200. This offset process may allow the data point to be converted into a way point, such as way point 440(A), usable by another apparatus having a different configuration. For example, two combine harvesters with different width headers may be able to work alternating rows, following each others' created waylines, as the offset process takes the header width into account.

Second wayline 420 may be created by assembling the second plurality of way points 440(A)-440(N) into a navigation path for later use by apparatus 200 and/or another apparatus. This assembly may be performed, for example, by apparatus 200 and/or field management system 160.

An embodiment consistent with the invention may comprise a system for providing a machine wayline. The system may comprise a memory storage and a processing unit coupled to the memory storage. The processing unit may be operative to create a first wayline by a first machine, provide the wayline to a second machine, and create a second wayline by the second machine as it traverses the first wayline. The processing unit may be further operative to estimate a meeting location for the first and/or second machines and a support machine from data points associated with the waylines. For example, data points may comprise an available volume remaining in a grain tank, remaining fuel, or a consumable supply level remaining for a sprayer machine. Based on rates of consumption (e.g., of sprayed consumable or storage space), a time and/or an amount of distance to be covered before the tank is full or the consumable is depleted may be estimated. The processing unit may be operative to correlate this distance with the machine's known trajectory according to its current wayline and identify a location to place a support vehicle, such as a field transport truck for offloading harvested material, a fuel truck, and/or a consumable supply vehicle. Consistent with embodiments of the invention, the processing unit may be operative to compute a common location for the support vehicle to intercept multiple working machines. For example, a location may be identified at which a first machine may be at 98% capacity while a second machine is at 92% capacity. This may be identified as an efficient common unloading location for the two machines such that one support vehicle may be used to offload both.

Another embodiment consistent with the invention may comprise an apparatus for providing wayline generation, the apparatus comprising a drive component operative to propel the apparatus, a work implement, an autosteer component coupled to the drive component and the work implement, and a way point generation component comprising a processing unit coupled to a memory storage. The autosteer component may be operative to receive a wayline, engage and disengage the work implement, and control a speed and direction of the apparatus via the drive component to maintain an edge of the work implement along a wayline. The processing unit of the way point generation component may be operative to identify a current location and orientation of the apparatus, translate the current location and orientation of the apparatus into a way point associated with an opposite edge of the work implement, record at least one characteristic of the apparatus, associate the at least one characteristic of the apparatus with the way point, and transmit the way point to a field management system. Translation of the current location and orientation of the apparatus into a way point may comprise computing an offset from a location of the GPS component in relation to worked area of the apparatus. For example, the translation may take into account the width of the work implement to know how much area the implement has covered; alternately, the translation may be aware of an area covered by a sprayer implement and may compute an offset so as to send a next pass of the sprayer across a different and/or overlapping area.

FIG. 5 is a block diagram of a system including a computing device 500. As shown in FIG. 5, computing device 500 may include a processing unit 525 and a memory 530. Memory 530 may comprise software modules such as a location offset module 535 and a data collection module 540. Field management system 160 may comprise a similar structure and may communicate with computing device 500 over network 180. While executing on processing unit 525, location offset module 535 and data collection module 540 may perform processes for receiving a position, creating a data point and/or a way point, transmitting data to and/or receiving data from field management system 160, and/or collecting sensor data. Computing device 500 may be operative to perform for example, one and/or more of method 300's stages as described above with respect to FIG. 3. Furthermore, one and/or more of method 300's stages may be performed by field management system 160.

Computing device 500 and/or field management system 160 may be implemented using a personal computer, network computer, mainframe, or other similar microcomputer-based workstation. The processors may comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processors may comprise other systems or devices.

Network 180 may comprise, for example, a local area network (LAN) or a wide area network (WAN). Such networking environments are commonplace in work sites, offices, enterprise-wide computer networks, intranets, and the Internet. When a LAN is used as network 180, a network interface located at any of the processors may be used to interconnect any of the processors. The processors may typically include an internal or external modem (not shown) or other means for establishing communications. Further, in utilizing network 180, data sent over network 180 may be encrypted to insure data security by using known encryption/decryption techniques.

A wireless communications system, or a combination of wire line and wireless may be utilized as network 180 in order to, for example, send and receive data points, way points, and/or waylines, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802), a Bluetooth interface, another RF communication interface, and/or an optical interface.

Computing device 500 may also transmit data by methods and processes other than, or in combination with, network 180. These methods and processes may include, but are not limited to, transferring data via, diskette, flash memory sticks, CD ROM, facsimile, conventional mail, an interactive voice response system (IVR), or via voice over a publicly switched telephone network.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing guidance, the method comprising:
receiving a field boundary line;
receiving a first work implement width;
calculating a first wayline at a distance from the field boundary line using the first work implement width, wherein the first work implement width is associated with a first machine;
providing the first wayline to a second machine;
receiving a second work implement width, wherein the second work implement width is associated with the second machine; and
calculating a second wayline at a distance from the first wayline using the second work implement width and the first wayline.

2. The method of claim 1, wherein calculating the first wayline comprises calculating the first wayline in response to the first machine harvesting a crop along the field boundary line.

3. The method of claim 1, wherein calculating the second wayline comprises calculating the second wayline in response to the second machine harvesting the crop along the first wayline.

4. The method of claim 1, wherein the first work implement width differs from the second work implement width.

5. The method of claim 1 further comprising estimating a meeting location for the first machine and a support machine according to the first wayline.

6. The method of claim 3, wherein each of the plurality of data points comprises at least one of the following: a speed of the first machine, a consumable supply level of the first machine, a location of the first machine, an orientation of the first machine, a remaining available volume of a harvest bin of the first machine, and a fuel supply level of the first machine.

7. The method of claim 3, wherein each of the plurality of data points comprises a set of coordinates as determined by a Global Positioning System (GPS) component associated with the first machine.

8. The method of claim 7, wherein each of the plurality of data points further comprises an offset value associated with a distance and orientation of the first work implement from the GPS component.

9. The method of claim 3, further comprising:
locating a first of the plurality of data points associated with the first wayline;
alerting an operator of the second machine to the existence of the first wayline;
determining whether the second machine should follow the first wayline; and
in response to determining that the second machine should follow the first wayline, activating an autosteer system of the second machine, wherein the autosteer system is operative to control a speed and an orientation of the second machine.

10. The method of claim 3, wherein providing the first wayline to the second machine comprises:
transmitting each of the plurality of data points associated with the first wayline to a field management system; and
requesting a location of any of the plurality of data points within a predetermined radius of a current location of the second machine from field management system 160.

11. An apparatus for providing guidance, the apparatus comprising:
a drive component operative to propel the apparatus;
a work implement;
an autosteer component coupled to the drive component and the work implement operative to:
receive a wayline,
engage and disengage the work implement, and
control a speed and direction of the apparatus via the drive component to maintain an edge of the work implement along the wayline; and
a way point generation component comprising a processing unit coupled to a memory storage, wherein the processing unit is operative to:
identify a current location and orientation of the apparatus via a Global Positioning System (GPS) component,
translate the current location and orientation of the apparatus into a way point associated with an opposite edge of the work implement,
record at least one characteristic of the apparatus,
associate the at least one characteristic of the apparatus with the way point, and
transmit the way point to a field management system.

12. The apparatus of claim 11, wherein being operative to translate the current location and orientation of the apparatus into a way point associated with an opposite edge of the work implement comprises being operative to compute an offset from a location of the GPS component in relation to a location and width of the work implement.

13. The apparatus of claim 11, wherein the way point generation component is operative to record the at least one characteristic of the apparatus while the work implement is engaged.

14. The apparatus of claim 11, wherein the at least one characteristic comprises a current level of a harvested material bin.

15. The apparatus of claim 14, wherein the field management system is operative to identify an unloading point for the apparatus according to the received at least one characteristic.

16. The apparatus of claim 14, wherein the field management system is further operative to identify a common unloading point for the apparatus and at least one second apparatus according to the received at least one characteristic from the apparatus and at least one corresponding characteristic received from the at least one second apparatus.

17. The apparatus of claim 11, wherein the field management system is operative to provide a plurality of generated way points to a second apparatus as a second wayline.

18. A system for providing guidance, the system comprising:
a memory storage; and
a processing unit coupled to the memory storage, wherein the processing unit is operative to:
receive a first plurality of data points, wherein each of the first plurality of data points comprises a location on a boundary between a worked area and an unworked area,
calculate a first wayline according to the first plurality of data points,
provide the first wayline to a machine comprising a work implement,
receive a second plurality of data points, wherein each of the second plurality of data points comprises a location at a distance from the first wayline of a width of the work implement, and
calculate a second wayline according to the second plurality of data points.

19. The system of claim 18, wherein the processing unit is further operative to: offset each of the first plurality of data points according to a predefined buffer amount.

20. The system of claim 19, wherein the predefined buffer amount is configured according to an accuracy of the GPS component.
